(19) United States
(12) Patent Application Publication
(10) Pub. No.: US 2025/0077405 A1
(43) Pub. Date: Mar. 6, 2025

(54) MANAGING SOFTWARE APPLICATION TEST INTERACTION

(71) Applicant: Kinaxis Inc., Ottawa (CA)

(72) Inventors: Rustam SHOR, Ottawa (CA); Sara HASSAN, Ottawa (CA); Ethann YAKABUSKI, Ottawa (CA); Gabriel LEMIEUX, Ottawa (CA); Muhammad SAWAL, Ottawa (CA); Yong CHEN, Ottawa (CA); Sharokh KHANI, Ottawa (CA); Jay PELLETIER, Ottawa (CA)

(21) Appl. No.: 18/817,711

(22) Filed: Aug. 28, 2024

Related U.S. Application Data
(63) Continuation-in-part of application No. 18/797,582, filed on Aug. 8, 2024.
(60) Provisional application No. 63/520,892, filed on Aug. 21, 2023.

(51) Int. Cl. G06F 11/36

(52) U.S. Cl. CPC G06F 11/3698

(57) ABSTRACT

A system and method for managing software application test interaction may include: obtaining, by a processor, initial actuation data associated with user actuation of a webpage object, the webpage object being associated with a server-side data object; obtaining, by the processor, server-side data associated with the actuation data and with the server-side data object; generating, by the processor, contextual data object actuation display data based on the initial actuation data and on the server-side data; and causing, by the processor, display of the contextual data object actuation display data. Such a solution addresses issues with existing approaches by automating, for example recording and playing back, actions including clicking on a specific location within a static interface, where a different action is performed depending on the location of the click.

### CROSS-REFERENCE TO RELATED APPLICATIONS

The present application is a continuation-in-part of U.S. Ser. No. 18/797,582 (filed Aug. 8, 2024), which claims the benefit of U.S. Ser. No. 63/520,892, filed Aug. 21, 2023, each of which is expressly incorporated by reference in its respective entirety herein.

### BACKGROUND

Web-based automation tools are used across the industry to create comprehensive end-to-end style tests for web-based software and applications.

Existing web-based test automation tools lack the capability of interacting with special components inside a particular platform.

### BRIEF SUMMARY

The details of one or more embodiments of the subject matter of this specification are set forth in the accompanying drawings and the description below. Other features, aspects, and advantages of the subject matter may become apparent from the description, the drawings, and the claims.

The present disclosure provides a web-based test automation tool to create comprehensive end-to-end style tests for web-based software and applications, which is configured to interact with special components inside a particular platform. These objects may rely on custom server-side proprietary data objects that are being exported as a static object via image/canvas/inline frame (iframe) and displayed on the webpage.

Existing solutions/software for automating actions on these proprietary objects fall short when clicking on a specific location within the static interface performs subsequent actions depending on the location of the click. In contrast to known approaches, the present disclosure is configured to automate actions on proprietary objects, for example including when clicking on a specific location within a static interface performs subsequent actions depending on the location of the click.

Embodiments of the present disclosure may provide a solution to the above problem by snooping in and relaying the appropriate information between the web client and the server. Embodiments of the present disclosure may perform a “man in the middle” attack, or a similar function, between a web client and a server, so as to snoop on the network traffic and inject special functionality into the client.

By intercepting network requests, the solution may discern when special server-side objects are being interacted with. The solution may then converse with the server via an application programming interface (API) call to collect additional information that may be required to determine the precise component within the exported static image/canvas/iframe. The solution may then record an action containing required information needed to play back a “click” on the proprietary component.

During playback of the captured action, there may also be additional server queries and injected client functions performed in order to determine the exact position of the captured click for consistent and correct playback.

In an aspect, the present disclosure provides a computer-implemented method comprising: obtaining, by a processor, initial actuation data associated with user actuation of a webpage object, the webpage object being associated with a server-side data object; obtaining, by the processor, server-side data associated with the actuation data and with the server-side data object; generating, by the processor, contextual data object actuation display data based on the initial actuation data and on the server-side data; and causing, by the processor, display of the contextual data object actuation display data.

In an example embodiment, the method further comprises: detecting, by the processor, interaction with the server-side data object; and intercepting, by the processor, a network request between a webpage associated with the webpage object and a web server associated with the server-side data object.

In an example embodiment, the method further comprises performing, by the processor, a man-in-the-middle attack between a webpage associated with the webpage object and a web server associated with the server-side data object.

In an example embodiment, the method further comprises obtaining, via the processor, the server-side data from a web server associated with the server-side data object via an API call.

In an example embodiment, the user actuation may comprise clicking or tapping on the webpage object. In an example embodiment, the webpage object may comprise a static image, a canvas or an inline frame. In an example embodiment, the webpage object may comprise a node and the user actuation comprises expanding the node.

In an example embodiment, generating the contextual data object actuation display data comprises generating, by the processor, a user-friendly plain language description of the user actuation based on the initial actuation data and on the server-side data.

In an example embodiment, the method further comprises: accessing, by the processor, code associated with the user actuation; and translating, by the processor, the code to the user-friendly plain language description based on the server-side data.

In an example embodiment, the webpage object may be associated with a web application, and the method may further comprise translating, by the processor, the code to the user-friendly plain language description based on the server-side data and based on data associated with the server-side data object and with additional data associated with the web application.

In an example embodiment, the method further comprises recording, by the processor, the initial actuation data associated with the user actuation of the webpage object.

In an example embodiment, the initial actuation data may comprise information required to playback the recorded user actuation of the webpage object associated with the server-side data object.

In an example embodiment, the method further comprises playing back the initial user actuation data and the server-side data to replicate the recorded user actuation.

In another aspect, the present disclosure provides a system comprising: a processor; and a memory storing instructions that, when executed by the processor, configure the system to: obtain, by a processor, initial actuation data associated with user actuation of a webpage object, the webpage object being associated with a server-side data object; obtain, by the processor, server-side data associated with the actuation data and with the server-side data object; generate, by the processor, contextual data object actuation display data based on the initial actuation data and on the server-side data; and cause, by the processor, display of the contextual data object actuation display data.

In an example embodiment, the memory further stores instructions that, when executed by the processor, configure the system to: detect, by the processor, interaction with the server-side data object; and intercept, by the processor, a network request between a webpage associated with the webpage object and a web server associated with the server-side data object.

In an example embodiment, the memory further stores instructions that, when executed by the processor, configure the system to perform, by the processor, a man-in-the-middle attack between a webpage associated with the webpage object and a web server associated with the server-side data object.

In an example embodiment, the memory further stores instructions that, when executed by the processor, configure the system to obtain, via the processor, the server-side data from a web server associated with the server-side data object via an API call.

In an example embodiment, the user actuation may comprise clicking or tapping on the webpage object. In an example embodiment, the webpage object may comprise a static image, a canvas or an inline frame. In an example embodiment, the webpage object may comprise a node and the user actuation comprises expanding the node.

In an example embodiment, the memory further stores instructions that, when executed by the processor, configure the system to generate the contextual data object actuation display data including generating, by the processor, a user-friendly plain language description of the user actuation based on the initial actuation data and on the server-side data.

In an example embodiment, the memory further stores instructions that, when executed by the processor, configure the system to: access, by the processor, code associated with the user actuation; and translate, by the processor, the code to the user-friendly plain language description based on the server-side data.

In an example embodiment, wherein the webpage object is associated with a web application, the memory further stores instructions that, when executed by the processor, configure the system to translate, by the processor, the code to the user-friendly plain language description based on the server-side data and based on data associated with the server-side data object and with additional data associated with the web application.

In an example embodiment, the memory further stores instructions that, when executed by the processor, configure the system to record, by the processor, the initial actuation data associated with the user actuation of the webpage object.

In an example embodiment the initial actuation data comprises information required to playback the recorded user actuation of the webpage object associated with the server-side data object.

In an example embodiment, wherein the webpage object is associated with a web application, the memory further stores instructions that, when executed by the processor, configure the system to play back the initial user actuation data and the server-side data to replicate the recorded user actuation.

In a further aspect, the present disclosure provides a non-transitory computer-readable medium. The computer-readable medium includes instructions that when executed by a computer, cause the computer to: obtain, by a processor, initial actuation data associated with user actuation of a webpage object, the webpage object being associated with a server-side data object; obtain, by the processor, server-side data associated with the actuation data and with the server-side data object; generate, by the processor, contextual data object actuation display data based on the initial actuation data and on the server-side data; and cause, by the processor, display of the contextual data object actuation display data.

In an example embodiment, the non-transitory computer-readable medium further includes instructions that, when executed by the computer, cause the computer to: detect, by the processor, interaction with the server-side data object; and intercept, by the processor, a network request between a webpage associated with the webpage object and a web server associated with the server-side data object.

In an example embodiment, wherein the webpage object is associated with a web application, the memory further stores instructions that, when executed by the processor, configure the system to perform, by the processor, a man-in-the-middle attack between a webpage associated with the webpage object and a web server associated with the server-side data object.

In an example embodiment, wherein the webpage object is associated with a web application, the memory further stores instructions that, when executed by the processor, configure the system to obtain, via the processor, the server-side data from a web server associated with the server-side data object via an API call.

In an example embodiment, the user actuation may comprise clicking or tapping on the webpage object. In an example embodiment, the webpage object may comprise a static image, a canvas or an inline frame. In an example embodiment, the webpage object may comprise a node and the user actuation comprises expanding the node.

In an example embodiment, wherein the webpage object is associated with a web application, the memory further stores instructions that, when executed by the processor, configure the system to, when generating the contextual data object actuation display data: generate, by the processor, a user-friendly plain language description of the user actuation based on the initial actuation data and on the server-side data.

In an example embodiment, wherein the webpage object is associated with a web application, the memory further stores instructions that, when executed by the processor, configure the system to: access, by the processor, code associated with the user actuation; and translate, by the processor, the code to the user-friendly plain language description based on the server-side data.

In an example embodiment, wherein the webpage object is associated with a web application, the memory further stores instructions that, when executed by the processor, configure the system to, when the webpage object is associated with a web application, translate, by the processor, the code to the user-friendly plain language description based on the server-side data and based on data associated with the server-side data object and with additional data associated with the web application.

In an example embodiment, wherein the webpage object is associated with a web application, the memory further stores instructions that, when executed by the processor, configure the system to record, by the processor, the initial actuation data associated with the user actuation of the webpage object.

In an example embodiment, the initial actuation data comprises information required to playback the recorded user actuation of the webpage object associated with the server-side data object.

In an example embodiment, wherein the webpage object is associated with a web application, the memory further stores instructions that, when executed by the processor, configure the system to play back the initial user actuation data and the server-side data to replicate the recorded user actuation.

In another aspect, a system is provided, that includes a processor. The system also includes a memory storing instructions that, when executed by the processor, configure the system to: obtain, by a processor, initial actuation data associated with user actuation of a webpage object, the webpage object being associated with a server-side data object; obtain, by the processor, server-side data associated with the actuation data and with the server-side data object; generate, by the processor, contextual data object actuation display data based on the initial actuation data and on the server-side data; cause, by the processor, display of the contextual data object actuation display data; and record, by the processor, the initial actuation data associated with the user actuation of the webpage object.

In an example embodiment, wherein the initial actuation data includes information required to playback the recorded user actuation of the webpage object associated with the server-side data object. In the example embodiment, the memory may further store instructions that, when executed by the processor, configure the system to play back the initial user actuation data and the server-side data to replicate the recorded user actuation. Other technical features may be readily apparent to one skilled in the art from the following figures, descriptions, and claims.

In another aspect, a non-transitory computer-readable medium is provided, the computer-readable medium including instructions that when executed by a computer, cause the computer to: obtain, by a processor, initial actuation data associated with user actuation of a webpage object, the webpage object being associated with a server-side data object; obtain, by the processor, server-side data associated with the actuation data and with the server-side data object; generate, by the processor, contextual data object actuation display data based on the initial actuation data and on the server-side data; cause, by the processor, display of the contextual data object actuation display data; and record, by the processor, the initial actuation data associated with the user actuation of the webpage object.

In an example embodiment, wherein the initial actuation data includes information required to playback the recorded user actuation of the webpage object associated with the server-side data object. In the embodiment, the non-transitory computer-readable medium may further include instructions that, when executed by the computer, cause the computer to play back the initial user actuation data and the server-side data to replicate the recorded user actuation. Other technical features may be readily apparent to one skilled in the art from the following figures, descriptions, and claims.

In another aspect, a computer-implemented method is provided that includes: obtaining, by a processor, initial actuation data associated with user actuation of a webpage object, the webpage object being associated with a server-side data object; obtaining, by the processor, server-side data associated with the actuation data and with the server-side data object; generating, by the processor, contextual data object actuation display data based on the initial actuation data and on the server-side data; causing, by the processor, display of the contextual data object actuation display data; and recording, by the processor, the initial actuation data associated with the user actuation of the webpage object.

In an example embodiment, wherein the initial actuation data includes information required to playback the recorded user actuation of the webpage object associated with the server-side data object. In the embodiment, the computer-implemented method may further include playing back the initial user actuation data and the server-side data to replicate the recorded user actuation. Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for managing software application test interaction in accordance with one embodiment.

FIG. 2 illustrates a flow chart of an example computer implemented method for managing software application test interaction in accordance with one embodiment.

FIG. 3 illustrates an example of another system for managing software application test interaction in accordance with one embodiment.

FIG. 4 illustrates an example of code generation in a system for managing software application test interaction in accordance with one embodiment.

FIG. 5 illustrates an example of a proxy server in a system for managing software application test interaction in accordance with one embodiment.

FIG. 6 illustrates an example of test runner functionality in a system for managing software application test interaction in accordance with one embodiment.

FIG. 7 illustrates an example of a testing framework in a system for managing software application test interaction in accordance with one embodiment.

FIG. 8 illustrates an example of a user interface showing a display relating to click recording in a system for managing software application test interaction in accordance with one embodiment.

FIG. 9 illustrates an example of a user interface corresponding to inspection of a node according to a known approach.

FIG. 10 illustrates an example of a user interface showing code associated with recording a click corresponding to inspection of a node in a system for managing software application test interaction in accordance with one embodiment.

FIG. 11 illustrates an example of a user interface showing user-friendly code associated with recording of a click in a specific area of a canvas in a system for managing software application test interaction in accordance with one embodiment.

FIG. 12 illustrates an example of a user interface showing a comparison of an output on the left of a system for managing software application test interaction in accordance with one embodiment, compared to an output on the right of a known system.

FIG. 13 illustrates an example of a user interface showing code associated with recording of a click in a specific area of a canvas, and associated with generated user-friendly code, in a system for managing software application test interaction in accordance with one embodiment.

FIG. 14 illustrates an example of a user interface showing the ability to run tests by interacting with a folder in a system for managing software application test interaction in accordance with one embodiment.

FIG. 15 illustrates an example of a user interface associated with playback of recorded script details, or running a test, showing a highlighted currently executing element in a system for managing software application test interaction in accordance with one embodiment.

FIG. 16 illustrates an example of a user interface associated with validating a cell in a system for managing software application test interaction in accordance with one embodiment.

FIG. 17 illustrates an example of a user interface associated with validating visible children nodes in a system for managing software application test interaction in accordance with one embodiment.

FIG. 18 illustrates an example of a user interface associated with validating a node performance meter in a system for managing software application test interaction in accordance with one embodiment.

### DETAILED DESCRIPTION

The present disclosure provides a web-based test automation tool that may be configured to create comprehensive end-to-end style tests for web-based software and applications, and may be configured to interact with special components inside a particular platform. These objects may rely on custom server-side proprietary data objects that are being exported as a static objects via image/canvas/iframe and displayed on the webpage.

Existing solutions/software for automating actions on these proprietary objects fall short when clicking on a specific location within the static interface performs subsequent actions depending on the location of the click. In contrast to known approaches, the present disclosure is configured to automate actions on proprietary objects, for example including when clicking on a specific location within a static interface performs subsequent actions depending on the location of the click.

Embodiments of the present disclosure may provide a solution to the above problem by snooping in and relaying the appropriate information between the web client and the server. Embodiments of the present disclosure may perform a “man in the middle” attack, or a similar function, between a web client and a server, so as to snoop on the network traffic and inject special functionality into the client.

By intercepting network requests, the solution may discern when special server-side objects are being interacted with. The solution may then converse with the server via an application programming interface call to collect additional information that may be required to determine the precise component within the exported static image/canvas/ifame. The solution may then record an action containing required information needed to play back a “click” on the proprietary component.

During playback of the captured action, there may also be additional server queries and injected client functions performed in order to determine the exact position of the captured click for consistent and correct playback.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

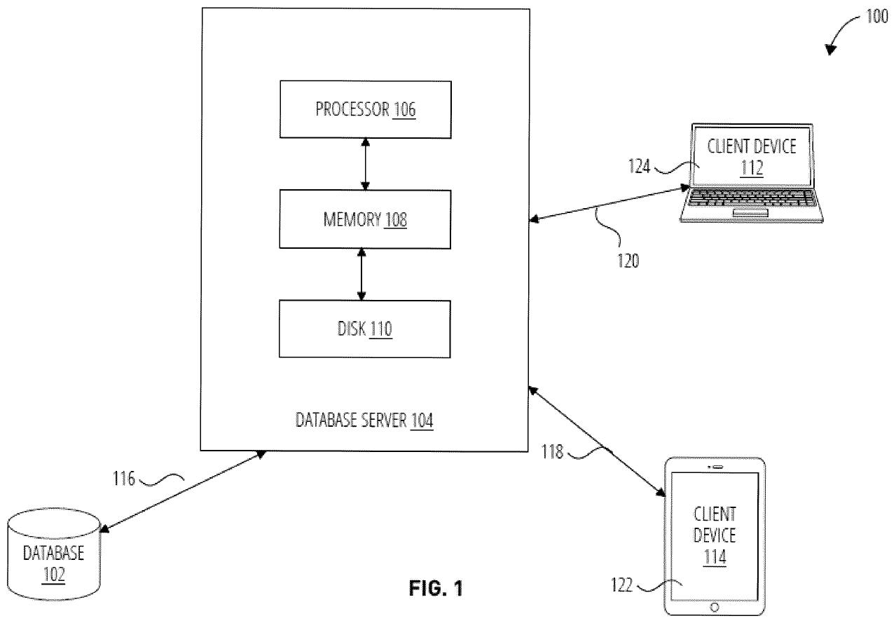

FIG. 1 illustrates an example of a system 100 for supply chain optimization.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

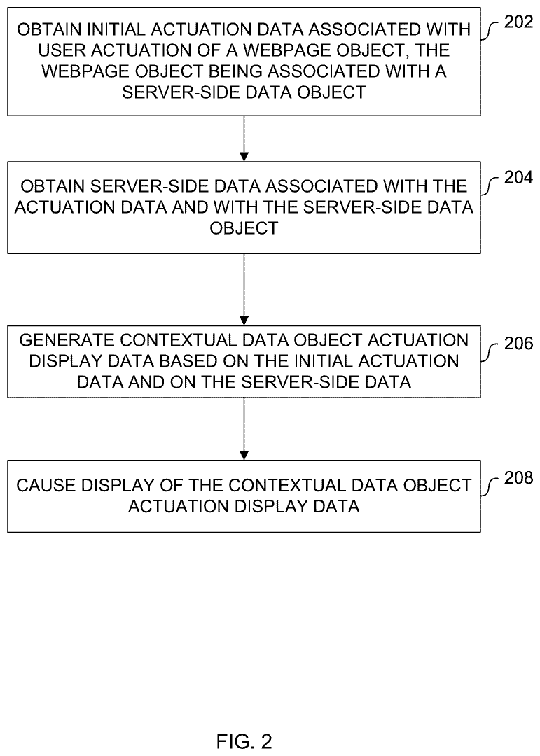

Referring now to FIG. 2, a flow chart illustrating an example computer implemented method for managing software application test interaction. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At 202, initial actuation data is obtained by a processor. The initial actuation data is associated with user actuation of a webpage object. The webpage object may be associated with a server-side data object. The user actuation may comprise clicking or tapping on the webpage object. The webpage object may comprise a static image, a canvas or an inline frame (iframe). The webpage object may comprise a node and the user actuation may comprise expanding the node.

At 204, server-side data is obtained by the processor. The server-side data is associated with the actuation data and with the server-side data object.

At 206, contextual data object actuation display data is generated by the processor. The contextual data object actuation display data may be generated based on the initial actuation data and on the server-side data.

Generating the contextual data object actuation display data may comprise: generating, by the processor, a user-friendly plain language description of the user actuation based on the initial actuation data and on the server-side data. The method may further comprise: accessing, by the processor, code associated with the user actuation; and translating, by the processor, the code to the user-friendly plain language description based on the server-side data. When the webpage object is associated with a web application, the method may further comprise: translating, by the processor, the code to the user-friendly plain language description based on the server-side data and based on data associated with the server-side data object and with additional data associated with the web application.

At 208, the processor causes display of the contextual data object actuation display data, for example on a display device.

The method may further comprise: detecting, by the processor, interaction with the server-side data object; and intercepting, by the processor, a network request between a webpage associated with the webpage object and a web server associated with the server-side data object.

The method may further comprise performing, by the processor, a man-in-the-middle attack between a webpage associated with the webpage object and a web server associated with the server-side data object.

The method may further comprise obtaining, via the processor, the server-side data from a web server associated with the server-side data object via an API call.

The method may further comprise recording, by the processor, the initial actuation data associated with the user actuation of the webpage object. The initial actuation data may comprise information required to playback the recorded user actuation of the webpage object associated with the server-side data object. The method may further comprise playing back the initial user actuation data and the server-side data to replicate the recorded user actuation.

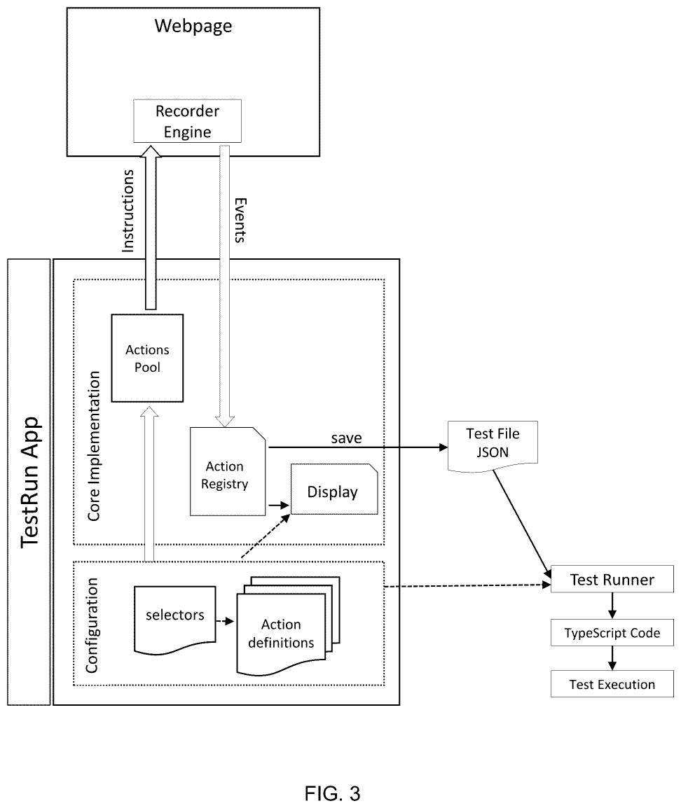

FIG. 3 illustrates an example of another system for managing software application test interaction in accordance with one embodiment.

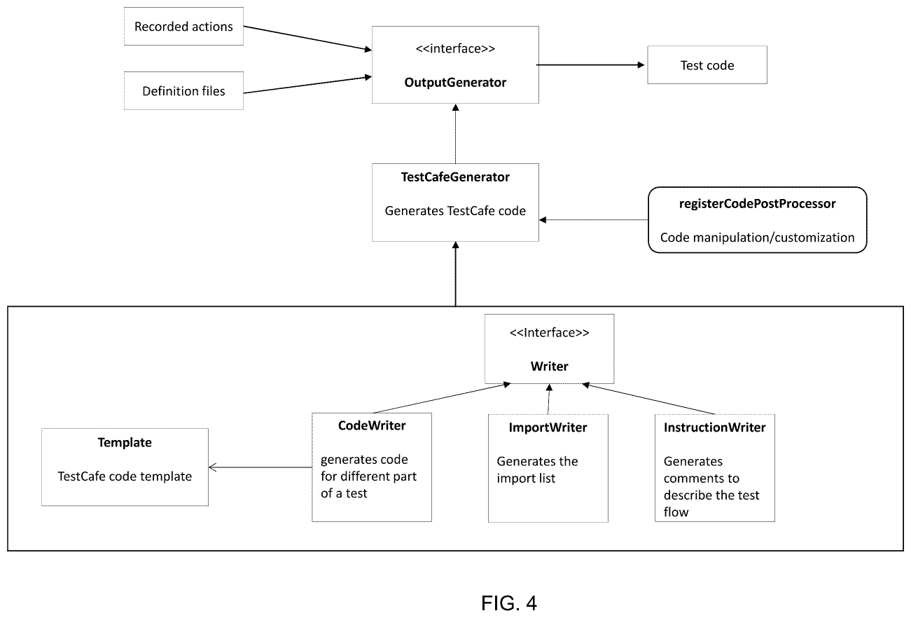

FIG. 4 illustrates an example of code generation in a system for managing software application test interaction in accordance with one embodiment.

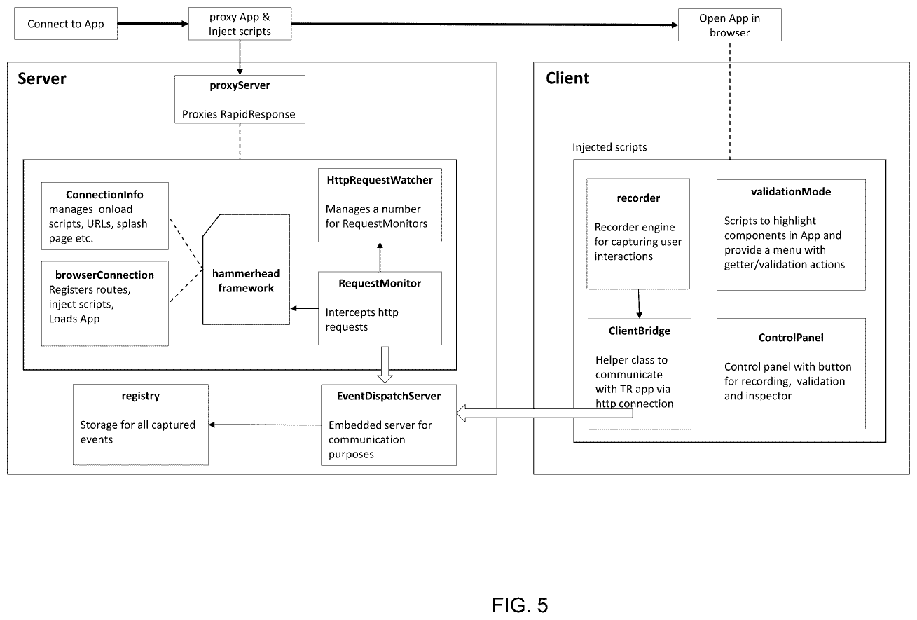

FIG. 5 illustrates an example of a proxy server in a system for managing software application test interaction in accordance with one embodiment.

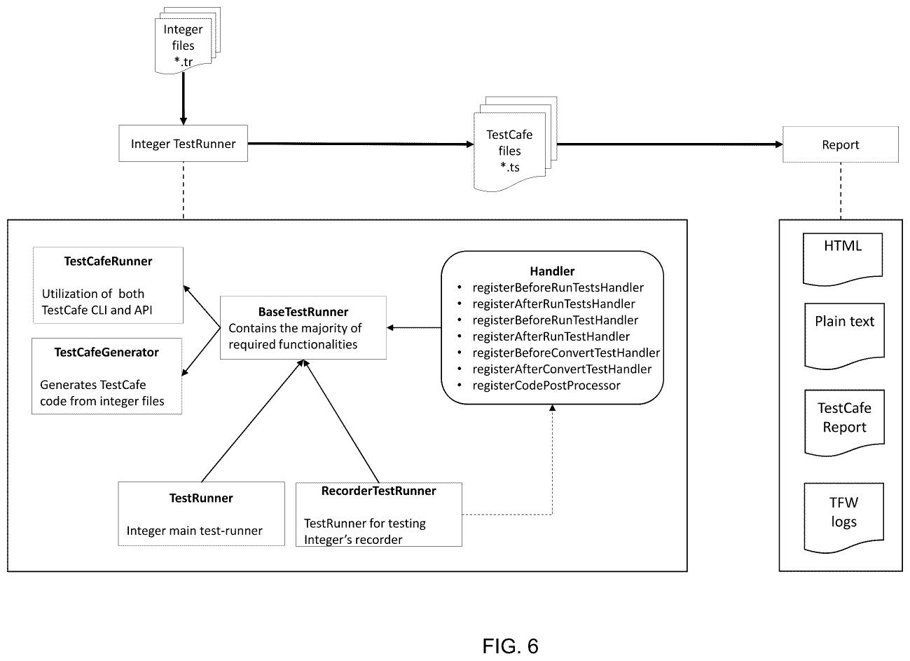

FIG. 6 illustrates an example of test runner functionality in a system for managing software application test interaction in accordance with one embodiment.

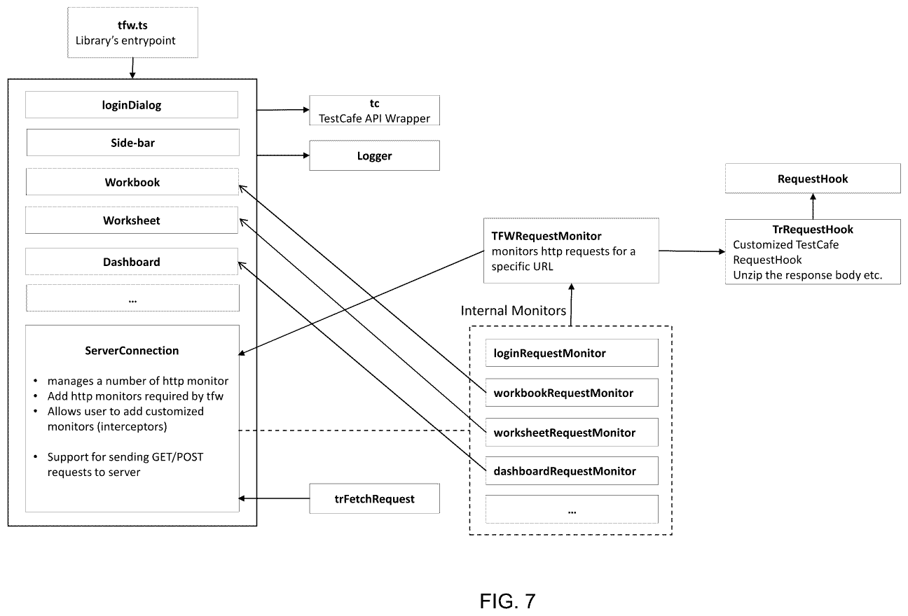

FIG. 7 illustrates an example of a testing framework in a system for managing software application test interaction in accordance with one embodiment.

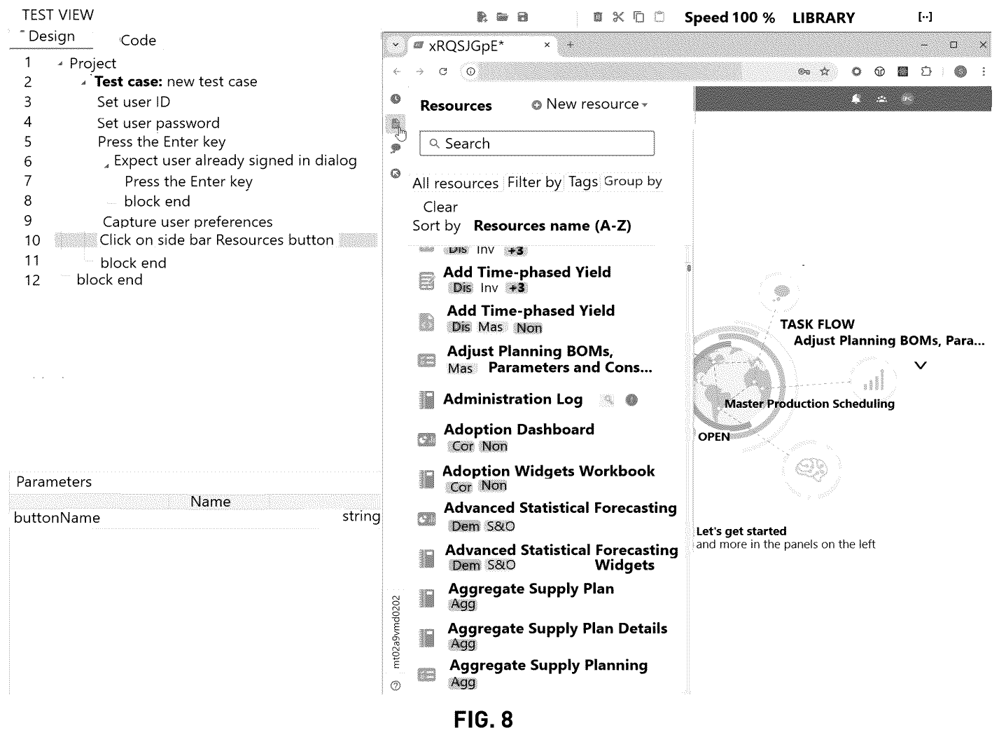

FIG. 8 illustrates an example of a user interface showing a display relating to click recording in a system for managing software application test interaction in accordance with one embodiment.

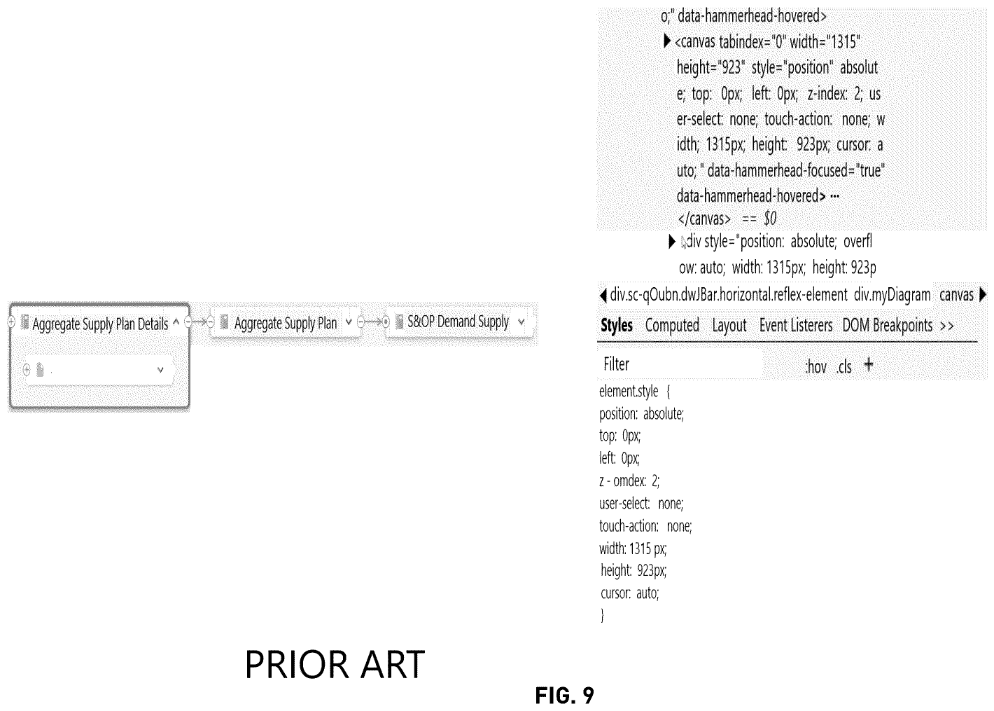

FIG. 9 illustrates an example of a user interface corresponding to inspection of a node according to a known approach.

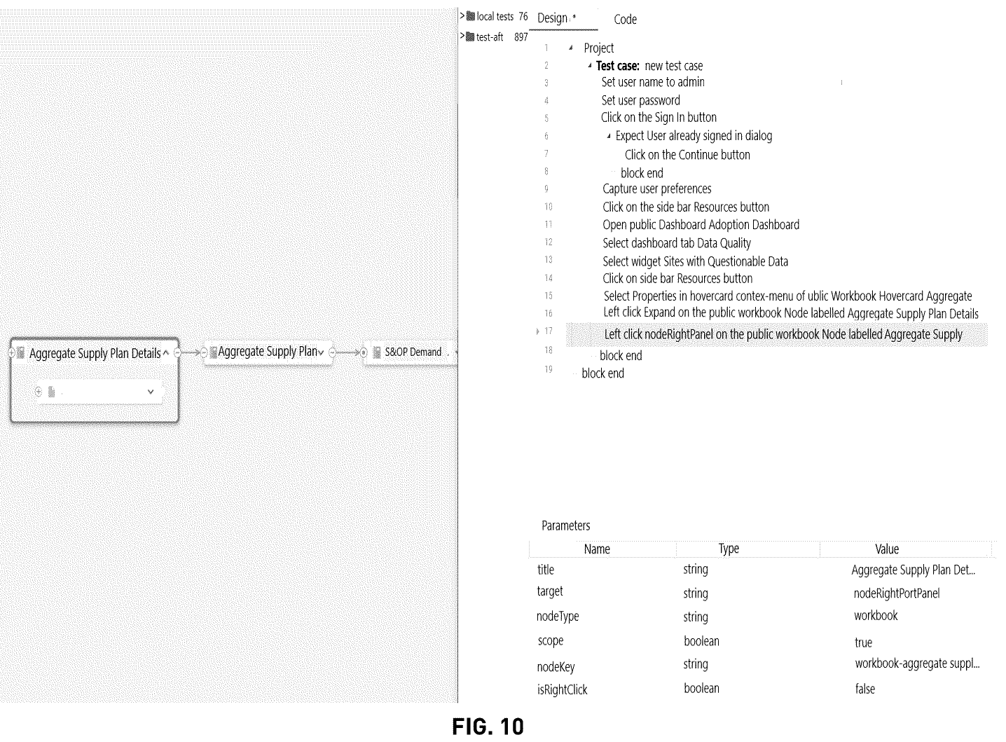

FIG. 10 illustrates an example of a user interface showing code associated with recording a click corresponding to inspection of a node in a system for managing software application test interaction in accordance with one embodiment.

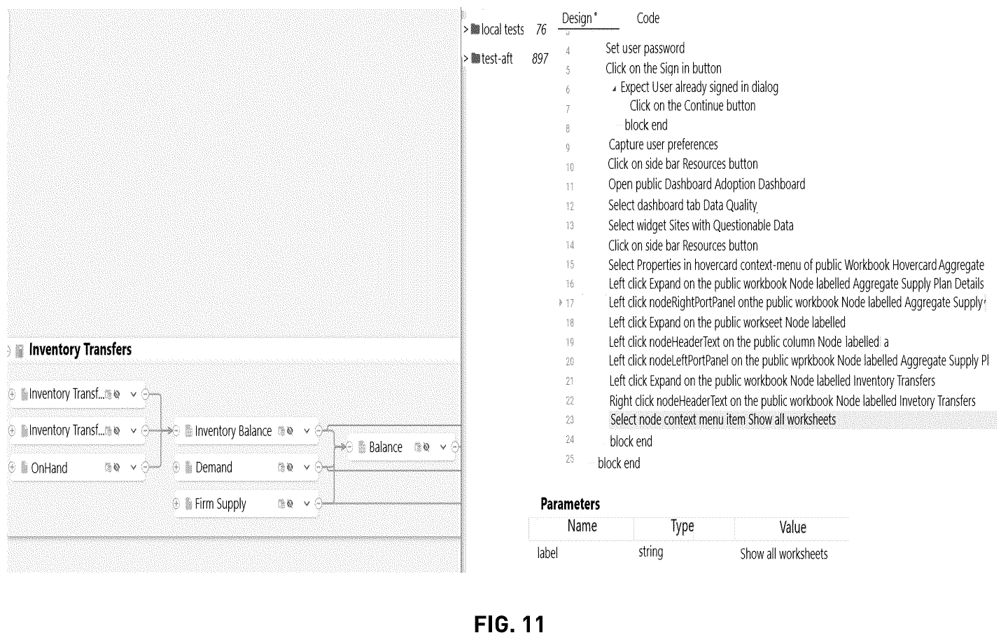

FIG. 11 illustrates an example of a user interface showing user-friendly code associated with recording of a click in a specific area of a canvas in a system for managing software application test interaction in accordance with one embodiment.

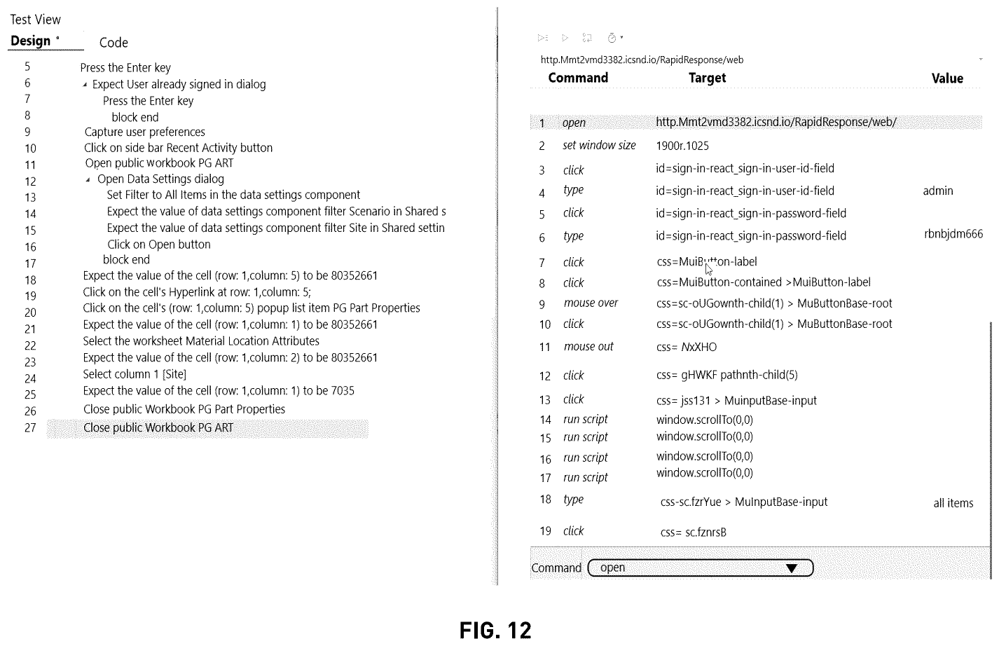

FIG. 12 illustrates an example of a user interface showing a comparison of an output on the left of a system for managing software application test interaction in accordance with one embodiment, compared to an output on the right of a known system.

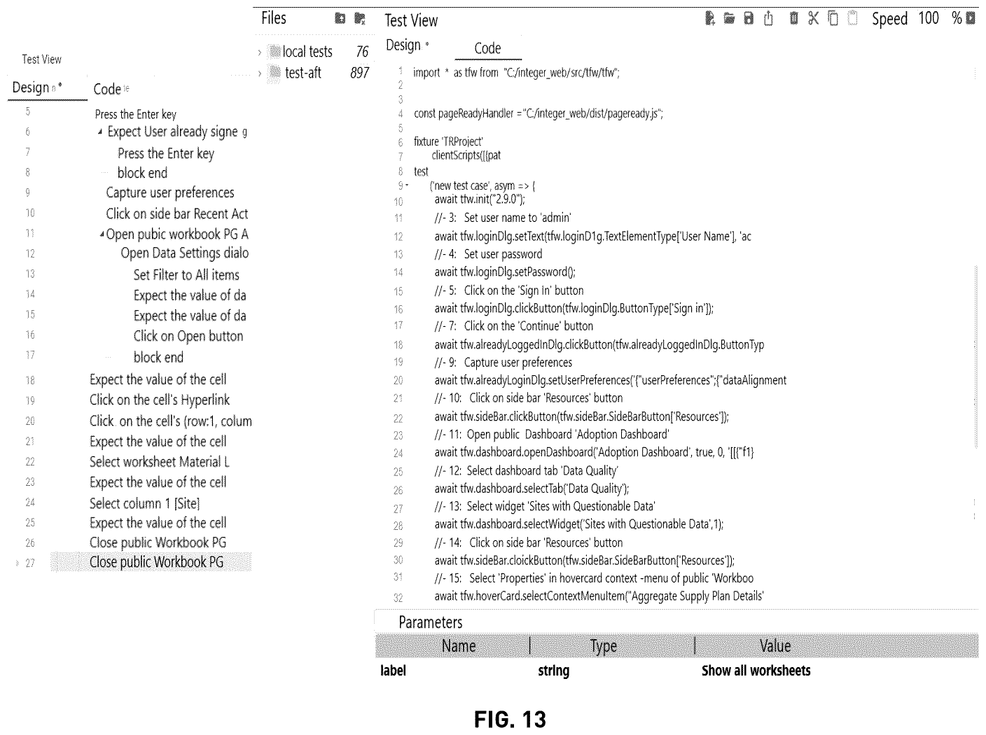

FIG. 13 illustrates an example of a user interface showing code associated with recording of a click in a specific area of a canvas, and associated with generated user-friendly code, in a system for managing software application test interaction in accordance with one embodiment.

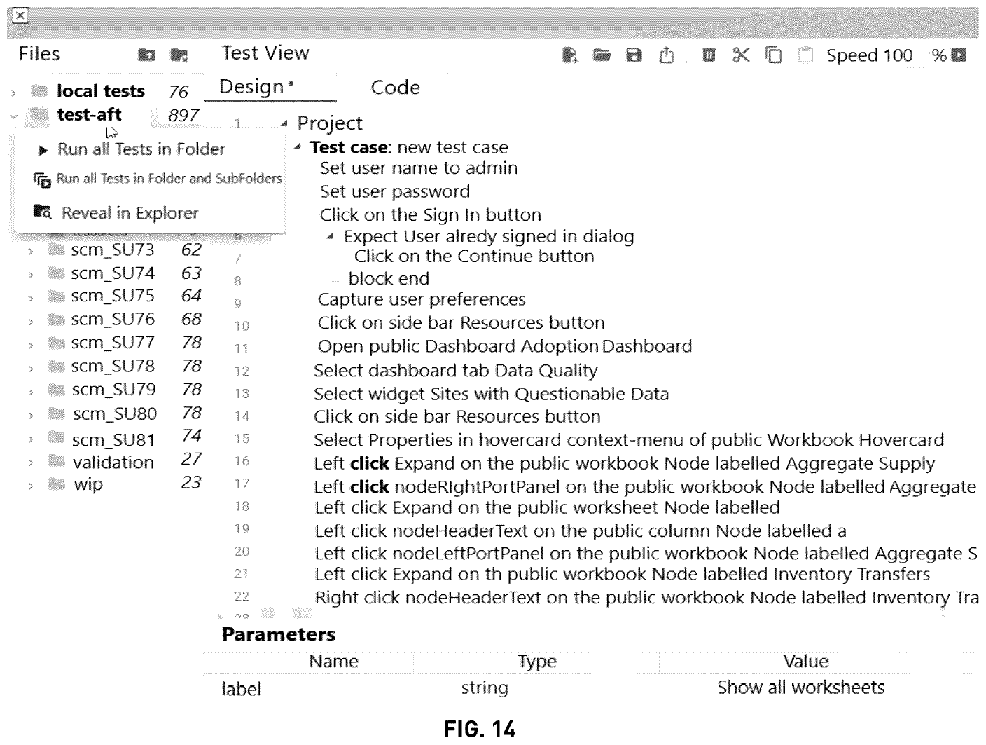

FIG. 14 illustrates an example of a user interface showing the ability to run tests by interacting with a folder in a system for managing software application test interaction in accordance with one embodiment.

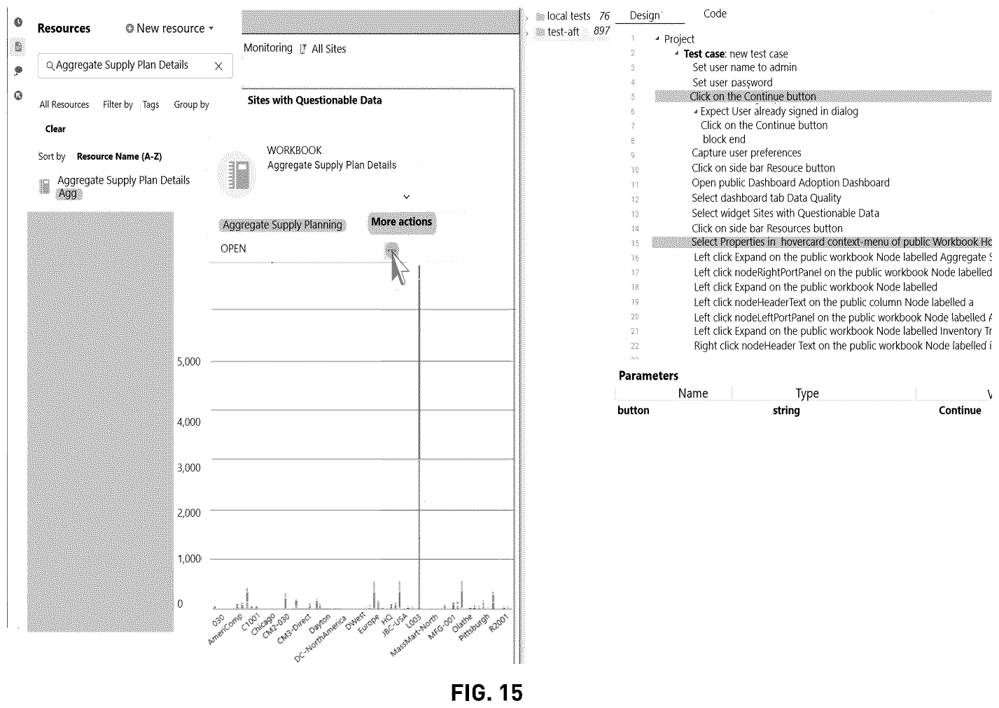

FIG. 15 illustrates an example of a user interface associated with playback of recorded script details, or running a test, showing a highlighted currently executing element in a system for managing software application test interaction in accordance with one embodiment.

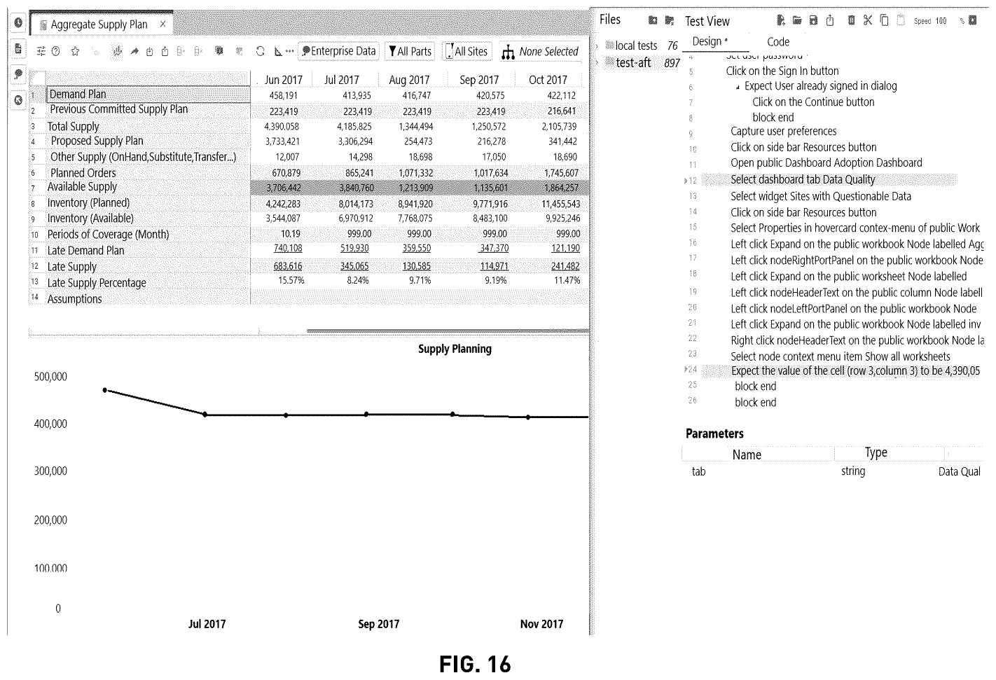

FIG. 16 illustrates an example of a user interface associated with validating a cell in a system for managing software application test interaction in accordance with one embodiment. Validation of a single cell may be performed to help validate data as being consistent from one version of the software application to another, for example when taking on a new update. Validation may comprise validation of an entire worksheet, where such validation comprises a set of cell validations.

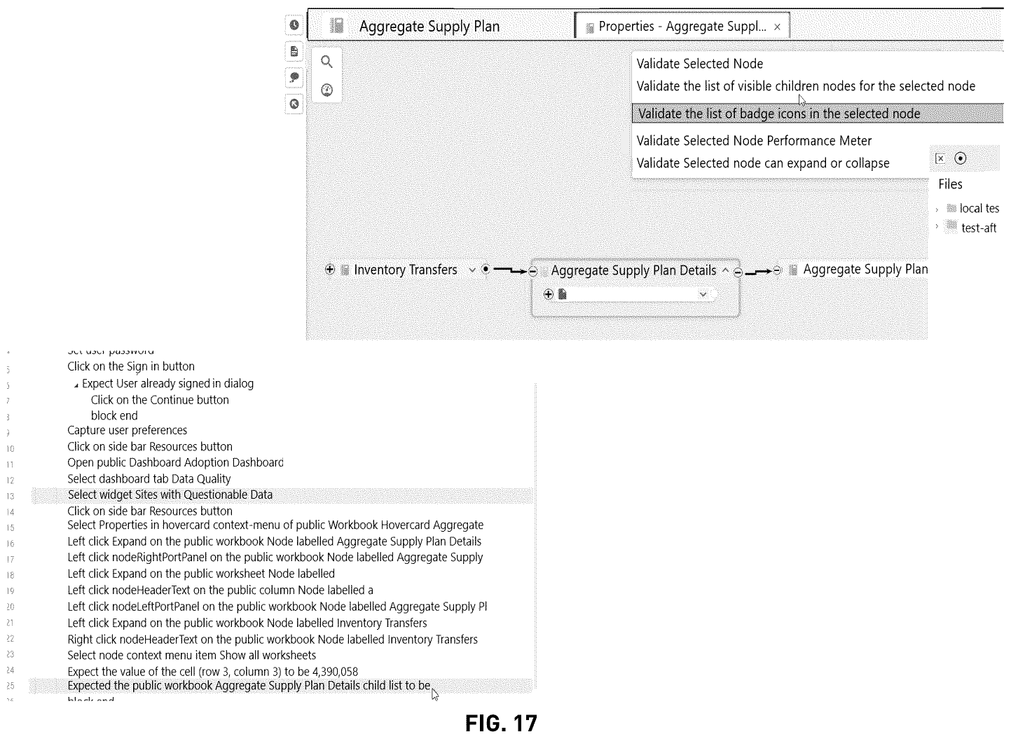

FIG. 17 illustrates an example of a user interface associated with validating visible children nodes in a system for managing software application test interaction in accordance with one embodiment. In an implementation, the system may validate children nodes for a selected node and/or validate an expansion state of a node.

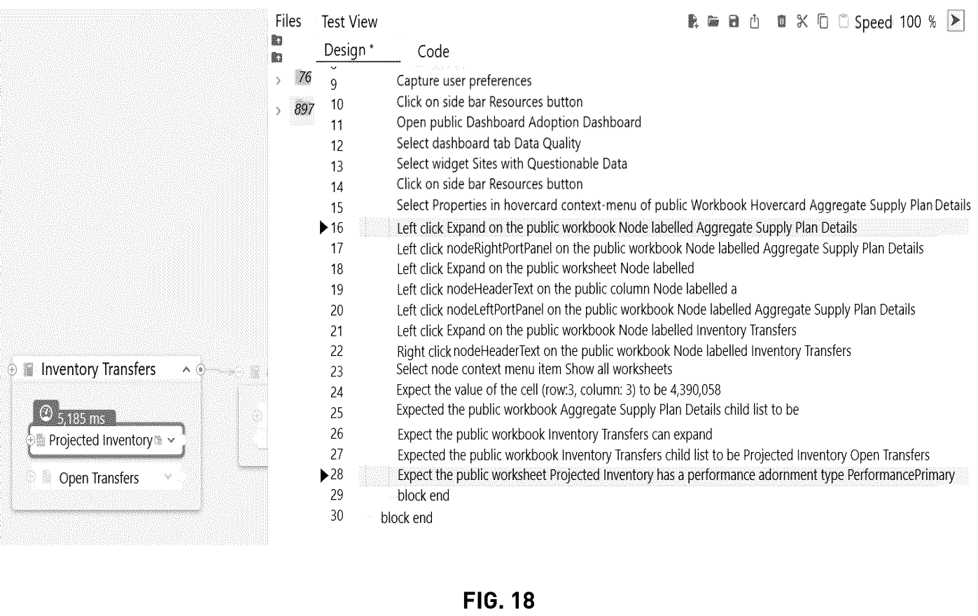

FIG. 18 illustrates an example of a user interface associated with validating a node performance meter in a system for managing software application test interaction in accordance with one embodiment.

Embodiments of the present disclosure may also provide backward compatibility. For example, suppose in an upgrade of the software application, there is a change from use of the term Reports to Resources in the underlying code. If a first version of the software application is installed and the expression “Click [id=Reports]” is recorded using a known approach, on playback this test would fail, since the expression Reports is not be present in the upgraded version. This would require manual intervention for a person to spend time to fix the test.

In contrast, if a first version of the software application is installed and the expression “Click SideBar button Reports” is recorded using a system according to an embodiment of the present disclosure, on playback this test would succeed. Success may be based on the system recording the user actuation in terms of the current version of the software and/or the system translating the underlying code into user-friendly terminology. Since the system is already configured to translate from the underlying code to the user-friendly terminology, the system may be configured to translate from expressions in an earlier version of the software to equivalent expressions in an upgraded version of the software. Embodiments of the present disclosure may be configured to automatically patch the action “Click SideBar button Reports” to “Click SideBar button Resources” in the upgraded version, resulting in a passing test and avoiding the need for any manual maintenance.

According to one or more embodiments, the present disclosure describes a system and method for managing software application test interaction. The system and method may include a number of aspects including: obtaining, by a processor, initial actuation data associated with user actuation of a webpage object, the webpage object being associated with a server-side data object; obtaining, by the processor, server-side data associated with the actuation data and with the server-side data object; generating, by the processor, contextual data object actuation display data based on the initial actuation data and on the server-side data; and causing, by the processor, display of the contextual data object actuation display data. Such a solution addresses issues with existing approaches by automating, for example recording and playing back, actions including clicking on a specific location within a static interface, where a different action is performed depending on the location of the click.

By generating and causing display of contextual data object actuation display data, based on the initial actuation data and on the server-side data, the overall functioning of the computer system, such as the example system 100 described previously, may be improved by facilitating performing accurate recording and playback of user actuation actions using reduced computational resources. Such improvements may include, for example, reduced computing time, reduced computer memory requirements, and reduced computer processor requirements, compared to known approaches, while also producing enhanced functionality and increased accuracy. Such improvements and solutions to computer problems are achieved by the methods of one or more of the embodiments described and illustrated herein.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor; and
a memory storing instructions that, when executed by the processor, configure the system to:
obtain, by a processor, initial actuation data associated with user actuation of a webpage object, the webpage object being associated with a server-side data object;
obtain, by the processor, server-side data associated with the actuation data and with the server-side data object;
generate, by the processor, contextual data object actuation display data based on the initial actuation data and on the server-side data;
cause, by the processor, display of the contextual data object actuation display data; and
record, by the processor, the initial actuation data associated with the user actuation of the webpage object.

2. The system according to claim 1, wherein the initial actuation data comprises information required to playback the recorded user actuation of the webpage object associated with the server-side data object.

3. The system according to claim 2, wherein the memory further stores instructions that, when executed by the processor, configure the system to:
play back the initial user actuation data and the server-side data to replicate the recorded user actuation.

4. A non-transitory computer-readable medium, the computer-readable medium including instructions that when executed by a computer, cause the computer to:
obtain, by a processor, initial actuation data associated with user actuation of a webpage object, the webpage object being associated with a server-side data object;
obtain, by the processor, server-side data associated with the actuation data and with the server-side data object;
generate, by the processor, contextual data object actuation display data based on the initial actuation data and on the server-side data;
cause, by the processor, display of the contextual data object actuation display data; and
record, by the processor, the initial actuation data associated with the user actuation of the webpage object.

5. The non-transitory computer-readable medium according to claim 4, wherein the initial actuation data comprises information required to playback the recorded user actuation of the webpage object associated with the server-side data object.

6. The non-transitory computer-readable medium according to claim 5, further including instructions that, when executed by the computer, cause the computer to:
play back the initial user actuation data and the server-side data to replicate the recorded user actuation.

7. A computer-implemented method comprising:
obtaining, by a processor, initial actuation data associated with user actuation of a webpage object, the webpage object being associated with a server-side data object;
obtaining, by the processor, server-side data associated with the actuation data and with the server-side data object;
generating, by the processor, contextual data object actuation display data based on the initial actuation data and on the server-side data;
causing, by the processor, display of the contextual data object actuation display data; and
recording, by the processor, the initial actuation data associated with the user actuation of the webpage object.

8. The computer-implemented method according to claim 7, wherein the initial actuation data comprises information required to playback the recorded user actuation of the webpage object associated with the server-side data object.

9. The computer-implemented method according to claim 8, further comprising:
playing back the initial user actuation data and the server-side data to replicate the recorded user actuation.
